(19) United States
(12) Patent Application Publication
(10) Pub. No.: US 2003/0149629 A1
(43) Pub. Date: Aug. 7, 2003

(54) Method of point of sale investment

(76) Inventors: Bo. T. Claridge, Kansas City, MO (US); Damon Cash Claridge, Superior, CO (US)

Correspondence Address: SPENCER, FANE, BRITT & BROWNE, 1000 WALNUT STREET, SUITE 1400, KANSAS CITY, MO, 64106-2140, US

(21) Appl. No.: 10/068,542

(22) Filed: Feb. 6, 2002

(51) Int. Cl. G06F 17/60

(52) U.S. Cl. 705/17; 705/43; 705/44

(57) ABSTRACT

A method of investment is provided in which an option to perform an on-demand investment transaction is displayed to a purchaser at a point-of-sale terminal upon completion of a point-of-sale transaction. If the chooses to proceed with the investment a request will be transmitted to the purchaser's bank, which maintains information regarding the purchaser's investment preferences. Upon receipt of the purchaser's investment request, the bank will review the purchaser's investment preferences and complete the transaction.

### FIELD OF THE INVENTION

The present invention relates to a method of investment. The invention permits a purchaser to easily make on-demand contributions to investment accounts from point-of sale locations.

### BACKGROUND OF THE INVENTION

There is no question that most Americans possess a desire to save money and to secure their tomorrow, yet at the same time experience extreme difficulty in doing so. According to a recent Congressional Research Service report [June 2001] 61 percent of all Americans between the ages of 24 and 64 have no retirement savings account of any kind. Even with the immense popularity growth of 401(k) plans, [the value of 401(k) plans has grown from $91 billion in 1984 to $1 trillion in 1999] which signifies that Americans are willing to save if it can be done in a quick and convenient manner, 20 percent of American workers who are eligible for 401(k) programs still never invest in them. This percentage has remained constant over the past five years and, according to some analysts, can be attributed to confusion, inertia or limited income.

There are three types of “poor savers” who, for different reasons, find themselves intimidated by the current investment climate. First, there are those who make ample money to live on, but merely lack the self-discipline to implement a personal savings plan. Second, there are those who consistently live beyond their means and are convinced they don't have enough money to put even a small amount away for retirement. Third, the under thirty age group who see retirement as a long way off and find retirement plans too time consuming and confusing. When combined, these three types of “poor savers” makeup over half of the working population.

Many people who do invest for their retirement still lack a stable savings strategy. Statistical data, taken from the US Department of Commerce Bureau of Economic Analysis Overview of the Economy, shows that the general population is fickle with their savings, being heavily influenced by the ups and downs of the economy. In 1999, the American personal saving rate was 2.4% or 160.9 billion dollars. In 2000, with the booming economy, the rate dropped to 1.0% or 67.7 billion dollars. This was due to the fact that investors sold stocks and spent the money as opposed to saving it. During the first two quarters of 2001 the rate increased to 1.1% or 79.5 billion dollars. In September 2001 the rate was 4.6% or 349.7 billion dollars and only 18.5 billion in October 2001 (the decrease being attributed to the September 11th terrorist attacks). Such wishy-washy investing leads to an insecure future.

Even people who are willing to save and who have a more stable savings strategy, are often unable to save enough for their retirement. An Annual Retirement Confidence Survey [released in May 2000] stated that though more Americans workers were saving for retirement, they weren't saving enough because they underestimated their life-span. A man retiring at age 65 can expect to live on average until 81, and a woman until 84. The fastest-growing segment of the population is the over-85 segment. We can only assume that further medical advancement will continue to extend future life expectancy, making it increasingly more important for Americans to put more money into their retirement funds.

Additionally, many people who desire to invest often lack the opportunity to easily invest. Studies have shown women over the age of 33, earning more than $15,000 per year, to be more aggressive savers than men of similar age and income. Among workers earning $75,000 per year, the female participation rate in 401(k) plans is 87% compared to the male participation rate of 75%. Not only do women participate more frequently but also they invest a larger proportion of their pay in equities, as opposed to less risky fixed-income securities. Although female employees are likely to put more of their pay aside and invest more aggressively than men having equivalent levels of pay and tenure, females' 401(k) balances are lower because they generally earn less and have shorter job tenures than men. Thus, many women may be willing to participate in additional investment opportunities if available.

Part of the reason why so many people either do not invest at all, or tend to under invest for their retirement is because they do not have an investment system that permits them to easily contribute to retirement funds at a time when they are more conducive to spending money. Traditional savings plans usually require a person to initiate an automatic investment strategy, which requires that they set a predetermined amount to be contributed on a continuous basis. An automatic contribution system requires that a person budget their spending throughout the entire year, spending less in some months to balance months of heavier spending. Many people do not wish to estimate their spending needs months or even years in advance to make such a savings system work. Although, automatic investment strategies can be reduced or even terminated at any time by the investor, continuous modifications can become burdensome and lead to lack of desire to invest. Thus it would be beneficial if a person could easily invest for their retirement without initiating an automatic method of savings.

Currently a person's only alternative to automatic investment systems is to make manually on-demand contributions to their retirement investments. This requires the investor to first make a conscious decision that it is time to invest, and second, take actions necessary to accomplish an investment transaction (such as contact an investment broker, discuss investments, write a check, etc.). Because such an investment scheme requires self-discipline and a significant time commitment by the investor, most people will tend to make rather large one-time investments for a given time period rather than investing a little bit at a time over the same given time period. Often these one-time larger investments are less than a person would be willing to invest, or able to invest, if done in smaller intervals. This is because people tend to be more comfortable spending money in smaller amounts. Nevertheless, the value of small amounts of money that do not significantly impact an investor's financial position at any given time can cumulatively add up to a significant amount over an extended period of time. Thus, it would be beneficial if a person could easily invest relatively small amounts of money at any given time that they may so desire.

### SUMMARY OF THE INVENTION

A principal object of the present invention is to provide a method of investment that eliminates the laborious thought process, confusion and need for self-discipline tied to previous investment plans. Another object of the present invention is to provide an investment method that allows investors to make on-demand investments at times when they are conducive to spending, such as when they are completing a purchase transaction.

The above objectives are achieved by linking the individual investor's bank debit card or credit card to their investment accounts. First, the investor must associate investment-preference information with the debit/credit (the “purchasing account”) card account at their financial institution (“bank”). The investment-preference information basically includes a listing of account numbers to which the investor desires to contribute. Once the investment accounts are associated with the purchasing accounts, the investor can contribute to their retirement account at any retailer, bank, ATM machine, or similar point-of-sale terminal location. This enables the investor is to act as an investor at the same time the investor is acting as a purchaser, encouraging investment decisions at a time when the investor/purchaser is conducive to spending.

Upon completion of a point-of-sale transaction, the point-of-sale terminal displays a message to the purchasers offering an option to perform an on-demand investment transaction. If the purchaser chooses to initiate such a transaction, a request will be sent from the point-of-sale location to the purchaser's bank. The bank will receive the request, review the purchaser's predetermined investment strategy, and complete the investment for the desired amount. It's fast, easy and like the 401(k) the money is invested without being seen, which facilitates investing for those individuals who are not self-disciplined enough to take cash directly from their paycheck and place it in a savings account. Unlike the 401(k), this method does not require an investor to schedule automatic contributions.

In addition, the instant invention promotes investing with consistency. Because the investor can make their contribution from anywhere, such as their local grocery store, they are more likely to make it happen. After all, even in an economic slow-down, people still go to the grocery store (or to a retail establishment) on average 6-10 times per week, at which time they will be reminded to contribute to their retirement each time they use their card.

The amount of the investment can be selected by the purchaser at the point-of-sale location, or alternatively, the purchaser can designate a predetermined investment amount for all transactions as part of the purchaser's investment-preference information.

The purchaser can maintain multiple investment accounts, designating a primary-investment account for all investments to a predetermined limit, and a secondary-investment account to provide a roll-over for investments made in excess of the predetermined limit. This is beneficial for IRA's and the like, which have yearly contribution ceilings.

In a preferred embodiment of the instant invention, the purchaser can make multiple on-demand investment requests in a single day, which will be accumulated by the purchaser's bank until the end of the day when the investment transaction are completed by the bank. This will simplify the processing that is performed by the purchaser's bank.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a flow chart showing, generally, the method steps associated with the use of a preferred embodiment of the present inventive method at a point-of-sale location.

### DESCRIPTION OF THE PREFERRED EMBODIMENT

Preferred embodiments of the present invention are hereinafter described with reference to the accompanying drawings.

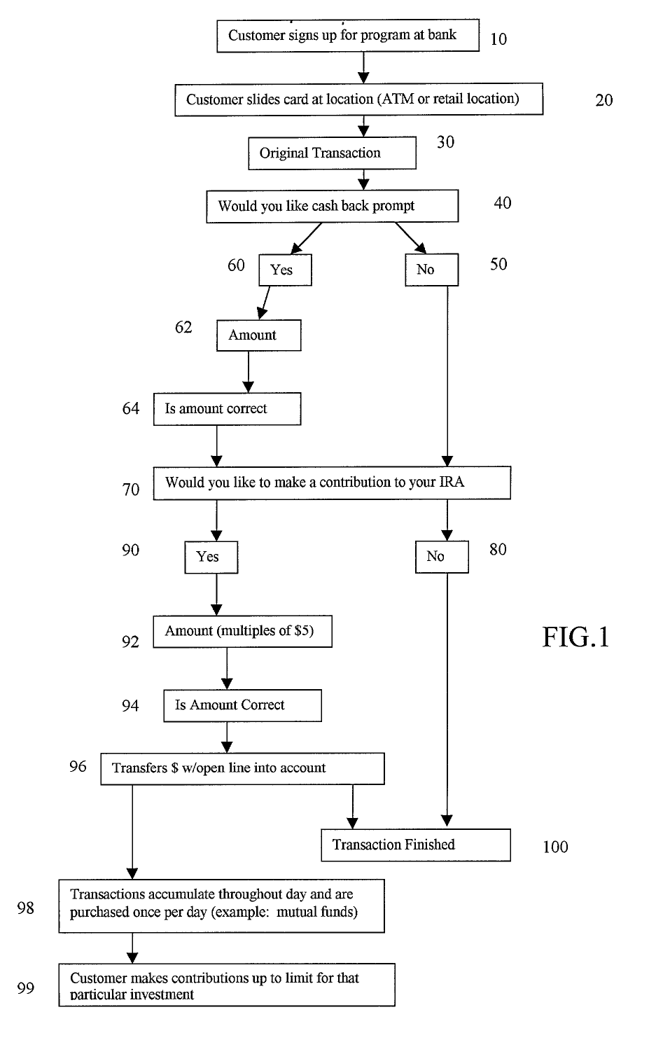

Referring to FIG. 1, a flow diagram showing the method steps associated with a preferred embodiment of the instant invention. The preferred embodiment of the instant invention allows a financial institution's customer to simultaneously act as both a purchaser and an investor by completing on-demand investment transactions at point-of-sale terminal locations.

To act as both a purchaser and an investor, the customer's purchase accounts must be linked to their investment accounts. In step 10 a customer contacts their bank, or other financial institution to enroll in the investment program of the instant invention. The customer will maintain a purchasing account with the financial institution. The customer will provide the financial institution with investment-preference information to associate the customer's purchasing accounts with investment accounts and enable the customer to make an on-demand investment transaction whenever that customer makes a point-of-sale purchase transaction.

The purchasing account can be a credit card account, a checking account, savings account, or any similar account from which the customer may perform point-of-sale transactions. Point-of-sale transactions include, but are not limited to, retail goods purchases, purchases of services (restaurants), online purchases, and banking/ATM transactions (deposits, withdrawals, balance inquiries).

Currently, most financial institutions will issue their customers a plastic credit card or debit card to be used at point-of-sale locations. The credit/debit card allows for easy, convenient access to the purchaser's account. In the preferred embodiment of the instant invention, the investor is issued a plastic debit card. It is understood that the inventive method does not necessitate the use of a plastic debit card; any alternative means of identifying an investor's purchasing account can be utilized. For example, an investor may simply enter an account number at a point-of-sale terminal location, rather than swiping a debit card.

In the preferred embodiment, the investment-preference information is maintained by the customer's financial institution; however, this information can also be stored on the debit card and transmitted to the financial institution at the time the customer requests the on-demand investment transaction. At the very least, the investment-preference information will include an account number for the customer's investment accounts. This is the account to which the customer desires that the on-demand investment be contributed. The investment preference-information can include additional information about the customer, such as additional investment account numbers, account balances, account limits, roll-over procedures, and fixed on-demand transaction amounts.

The investment account can be an account with the same financial institution as the purchasing account. Alternatively, the investment account can be an account with a separate financial institution, or a combination of accounts. In a situation in which separate financial institutions are used, the customer will need to provide authorization for funds to be transferred between institutions. This authorization can be obtained when the customer initially enrolls in the investment program of the instant invention. Some banks may chose to require customers' to maintain both a purchase account and an investment account at that institution to permit on-demand investments using the method of the instant invention. Nevertheless, such is not a requirement of the inventive method.

In the preferred embodiment of the instant invention the customer's investment account is linked to the individual's debit card account. The investment account is identified by the last four digits printed on the debit card. These digits direct the customer's money into a sub-account which can be an IRA, mutual fund, CD, stocks, or other similar investment account. Alternatively, identification of the investment account can be accomplished by magnetically encoding the account number, or identification number, on the customer's debit card.

Although the customer's investment account does not have to be maintained with the same institution as the purchase account, the financial institution will usually require some incentive to perform the services of completing on-demand investment requests of the instant invention for the customer. This can be in the form of a service fee per transaction, a monthly fee, or a one-time set-up fee. Alternatively, if a customer does maintain purchase and investment accounts with the same financial institution, the bank may require its customer's to provide a minimum deposit to open the investment account. As an incentive to the customer, the bank may chose to match the customer's initial deposit up to a set amount (i.e. $50.00). Like many other types of investment or savings accounts, the bank, at its discretion, may require a minimum monthly deposit into the customer's on-demand investment account. After completing the necessary paperwork to enroll in the investment program of the instant invention, the bank can provide the enrolled customer with a Wealth Accumulation Chart, which will show the potential growth of their account, based on a predetermined weekly contribution at an estimated interest rate. This chart will help new investors understand the value of compound interest, thus encouraging them to contribute to their investment account on a regular basis.

Once the customer has enrolled in the on-demand investment program of their financial institution and associated a purchase account with an investment account, the customer is ready to invest. In step 20 the financial institution customer now becomes a purchaser. The customer can purchase goods and/or services at a retail location, over the telephone, over the internet, or at any other point-of-sale location such as a bank or ATM machine. In the preferred embodiment, the customer purchases goods/services in person at a retail location. When it is time to pay for the goods/services, the merchant will total up the purchase amount at the register and the customer will slide their debit card through the cash register card reader to initiate the original point-of-sale transaction (i.e. purchase of an item). Additional customer confirmation, such as a PIN number, may be required to proceed with the transaction. This information can be input by the customer using a keypad located on the merchant's register.

In step 30 the purchase transaction information, including such information as transaction amount, customer account number, customer PIN number, is transmitted electronically to a host processor, which routes the transaction request to the customer's bank or financial institution. The funds for the point-of-sale transaction are then electronically transferred to the host processor's bank account and an approval code is transmitted from the host processor to the merchant. The point-of-sale purchase transaction can then be completed, and the host processor will ACH (automated clearing house) the funds for the purchase amount to the merchant's bank account (usually the next business day). This same, or similar process is currently used for virtually all point-of-sale transactions, including credit card purchases and ATM withdrawals.

In step 40 a message is displayed to the customer, requesting whether the customer would like to receive cash back as part of the purchase transaction. This is a common option that occurs when customers use their debit cards to purchase items at retail locations. If a customer chooses not to receive cash back, in step 50, the purchase transaction is completed for the amount of the purchase. If however, the customer chooses in step 60 to receive cash back during the point-of-sale purchase transaction, the customer will be prompted to enter an amount of cash that they desire. In step 62 the customer uses the keypad of the merchant's register to key in an amount of cash they desire. In step 64 the customer will be prompted to confirm that the amount is correct. The customer will then use the keypad to confirm that the amount is correct, or else to reenter the amount, or cancel the cash-back request entirely. Once the amount of cash back is confirmed, that amount will be added to the purchase transaction amount, and funds in the amount of the total transaction amount will be electronically transferred from the customer's purchase account to the merchant's bank account in the manner described above. The merchant will give the customer the items purchased as well as the additional cash requested by the customer.

Once the point-of-sale transaction is complete, including any amount of money that is to be transferred from the customer's purchase account to the merchant's bank account as cash-back to the customer, the investment process will begin. In step 70 the customer/purchaser is asked if they would like to make an on-demand investment transaction, i.e. if they would like to contribute to their IRA. In the preferred embodiment, this message is displayed on the merchant's register.

If the point-of-sale location is an ATM, the details of the transactions will vary slightly due to the fact that an ATM often offers a menu of options. The ATM can be programmed to display a specific prompt asking the customer whether the desire to make an on-demand investment transaction upon completion of their withdrawal (or other point-of-sale transaction, such as balance inquiry). Alternatively, most ATM's provide a menu of options for the customer to select a transaction, such as a withdrawal, a balance transfer between savings and checking, a balance inquiry, or a deposit. When such a menu is available the ATM can list on-demand investment transactions among its list of options.

If the customer chooses not to make an on-demand investment transaction, step 80, the point-of-sale transaction will be completed, step 100, with the customer having purchased the goods or services from the retailer and receiving any cash-back that has been requested. No contribution will be made to the customer's investment account. If however, the customer chooses to make an investment, step 90, the customer selects the amount to invest, step 92, and then confirms that the selected amount is correct, step 94. In the preferred embodiment, the customer/investor will select investment amounts in five dollar increments; however, any monetary increment can be used. Additionally, for ease of investing, the investor could choose a predetermined investment amount for all on-demand investment transactions. This predetermined amount would be selected when the customer enrolls in the investment program with their financial institution, and will become part of the customer's investment-preference information.

Once the customer confirms the amount they wish to contribute to their investment account, a request will be transmitted to the customer's bank, step 96, for the bank to complete the investment transaction and transfer the funds from the investor's purchase account to the appropriate investment account. At that point the customer has completed the on-demand investment, step 100, a receipt can be printed, if desired, and the customer can leave the merchant's register.

In the preferred embodiment, the customer's bank will receive the customer's on-demand investment request and accumulate all requests made by the customer throughout a single day, step 98. The bank will then complete the cumulated requests, by making a single transfer of funds from the purchase account to the investment account at the end of the day. This allows a customer to make as many on-demand investments as desired, while eliminating redundant efforts on the part of the bank to complete the investment transactions. This is especially beneficial when the customer's investment accounts are maintained at a separate financial institution from the purchase account.

Many investment accounts, such as an IRA, have a yearly contribution ceiling. Additionally customer's may wish to limit the total amount that they will contribute to a single investment account. In such situations, the customer may wish to have a secondary account into which any amounts in excess of the predetermined limits will roll-over. The customer will designate primary and secondary investment accounts when they enroll at their bank. In the preferred embodiment, the customer will designate a primary account into which all on-demand investment amounts will be contributed. When a customer makes an on-demand investment, the customer's bank will check the total amount already invested in that account and determine whether the investment will bring the total over the predetermined limit. If the investment will bring the total over the limit, then the bank can invest an amount in the primary investment account to bring the total to the exact amount of the limit. The remainder of the on-demand investment can then be contributed to the secondary investment account. If an investor has not designated a secondary account, the bank can either cancel the transaction, or it can reduce the amount of the on-demand investment to bring the account total to the investment limit. These banking options can all be prescribed in the enrollment contract between the bank and the customer.

The prompts to the customer, i.e. asking if they desire cash back, and asking if they wish to contribute to their investment account, can either be initiated by the point-of-sale terminal (i.e. the merchant's register) or they can be initiated from a central location (i.e. the bank). Which method is used will depend upon the communication link between the point-of-sale terminal and the bank. Initiation from the bank will require either a continuous connection between the terminal and the bank, or else multiple transmissions. Initiation from the point-of-sale terminal can allow all transaction information to be collected, i.e. purchase amount, cash-back amount and on-demand investment amount, before transmitting data between the merchant's register and the bank. This can reduce the overall connection time and number of transmissions. Such may be beneficial for merchants who do not have dedicated lines for their registers.

In the preferred embodiment of the invention, only customers who have enrolled in the investment program with their bank will be prompted to make on-demand investments at point-of-sale terminals. Nevertheless, it may be desirable to ask all point-of-sale purchasers if they desire to make an on-demand investment. This might inspire some purchasers to make an on-demand investment who otherwise lack the motivation to enroll in an investment program. In such a situation, a message can be displayed to the purchaser that they do not have an investment account, and that they should contact their financial institution to enroll in the program. Alternatively, an investment account (possibly a temporary account) can be automatically opened for the purchaser with the purchaser's financial institution. The purchaser's bank can then send enrollment information to the purchaser and enroll the purchaser in the investment program.

In the preferred embodiment, quarterly statements can be mailed to investors which will minimize the inertia associated with the concept of saving and encourage investors to continue to contribute to their investment accounts.

In the preferred embodiment of the instant invention, the customer's bank will have an automated system for completing the investment transactions. In most cases this can be done with existing technology that already permits banking customers to set up automatic funds transfers between accounts either within a single financial institution, or between multiple institutions. Such an automated system will require customer's to provide the bank with authorization for making such automatic transfers upon enrollment in the program.

An alternative embodiment of the instant invention can utilize smart-card technology, in which investment-preference information is stored in a microprocessor embedded in the card. In such an embodiment it may be possible to complete an on-demand investment transaction directly from a point-of-sale terminal, rather than requiring assistance from the purchaser's financial institution. The point-of-sale location would then directly make the electronic transfer of funds from the purchase account to the investment account.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method of investment is used, and advantageous, new and useful results obtained, the new and useful elements, arrangements and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A method of investment comprising the steps of:
at a point-of-sale location,
displaying an option to perform an on-demand investment transaction; and
transmitting a request to complete the on-demand investment transaction in response to an action by a purchaser at the point-of-sale location;
at a central location,
receiving the request to perform the on-demand investment;
retrieving investment-preference information for the purchaser; and
completing the on-demand investment using the investment-preference information.

2. The method of investment as claimed in claim 1 further comprising the step of prompting the purchaser to designate an investment amount for the on-demand investment.

3. The method of investment as claimed in claim 1 wherein the investment-preference information includes a predetermined investment amount for the on-demand investment.

4. The method of investment as claimed in claim 1 further comprising the step of temporarily accumulating the on-demand investment request until a predetermined completion time.

5. The method of investment as claimed in claim 1 further comprising the steps of:
comparing an investment total to a predetermined investment limit; and
canceling the on-demand investment request if completion of the on-demand investment will cause the investment total to exceed the predetermined investment limit.

6. The method of investment as claimed in claim 1 further comprising the steps of:
comparing a primary-investment total to a primary-investment limit; and
determining a roll-over amount for the on-demand investment request.

7. The method of investment as claimed in claim 6 wherein said step of completing the on-demand investment comprises the step of adding the roll-over amount to a secondary-investment total.

8. The method of investment as claimed in claim 1 wherein the investment-preference information comprises an investment total and a predetermined investment limit.

9. A method of investment comprising the steps of:
associating a purchasing account with an investment account;
prompting a user of the purchasing account to perform an on-demand investment transaction during a point-of-sale purchase transaction;
completing the on-demand investment transaction by contributing to the investment account upon receipt of a request from the user.

10. The method as claimed in claim 9 wherein said step of completing the on-demand investment transaction is accomplished by using the purchasing account to contribute to the investment account.

11. The method as claimed in claim 9 wherein said step of completing the on-demand investment transaction is accomplished by using a source other than the purchasing account to contribute to the investment account.
